(19) United States
(12) Patent Application Publication
(10) Pub. No.: US 2010/0218838 A1
(43) Pub. Date: Sep. 2, 2010

(54) Method and apparatus for providing a passageway between explosion proof enclosures

(75) Inventor: Joseph Michael Manahan, Manlius, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/368,925

(22) Filed: Mar. 6, 2006

(51) Int. Cl. F16L 9/00; B23P 11/00

(52) U.S. Cl. 138/109; 29/428

(57) ABSTRACT

An apparatus and method according to which a passageway is provided between explosion proof enclosures.

### BACKGROUND

The present disclosure relates in general to explosion proof enclosures and in particular to a method and apparatus for providing a passageway between explosion proof enclosures.

### BRIEF DESCRIPTION OF THE DRAWINGS

FIG. 1a is a front perspective view illustrating an exemplary embodiment of an explosion proof enclosure passageway apparatus.

FIG. 1b is a rear perspective view illustrating an exemplary embodiment of the explosion proof enclosure passageway apparatus of FIG. 1a.

FIG. 1c is a side view illustrating an exemplary embodiment of the explosion proof enclosure passageway apparatus of FIG. 1a.

FIG. 1d is a cross sectional view illustrating an exemplary embodiment of the explosion proof enclosure passageway apparatus of FIG. 1a.

FIG. 2a is a perspective view illustrating an exemplary embodiment of an explosion proof enclosure system used with the explosion proof enclosure passageway apparatus of FIGS. 1a, 1b, 1c, and 1d.

FIG. 2b is a perspective view illustrating an exemplary embodiment of the explosion proof enclosure system of FIG. 2a.

FIG. 2c is a cross sectional view illustrating an exemplary embodiment of the explosion proof enclosure system of FIG. 2b.

FIG. 3a is a flow chart illustrating an exemplary embodiment of a method for providing a passageway between explosion proof enclosures.

FIG. 3b is a partial cross sectional view illustrating an exemplary embodiment of the explosion proof enclosure passageway apparatus of FIG. 1c being coupled to the explosion proof enclosure system of FIG. 2c.

FIG. 3c is a partial cross sectional view illustrating an exemplary embodiment of the explosion proof enclosure passageway apparatus of FIG. 1c coupled to the explosion proof enclosure system of FIG. 2c.

FIG. 3d is a cross sectional view illustrating an exemplary embodiment of the explosion proof enclosure passageway apparatus of FIG. 1d coupled to the explosion proof enclosure system of FIG. 2c.

FIG. 3e is a cross sectional view illustrating an exemplary embodiment of the explosion proof enclosure passageway apparatus and the explosion proof enclosure system of FIG. 3d with a plurality of wires run through the explosion proof enclosure passageway apparatus.

FIG. 3f is a cross sectional view illustrating an exemplary embodiment of the explosion proof enclosure passageway apparatus and the explosion proof enclosure system of FIG. 3e with a sealant positioned around the plurality of wires.

### DETAILED DESCRIPTION

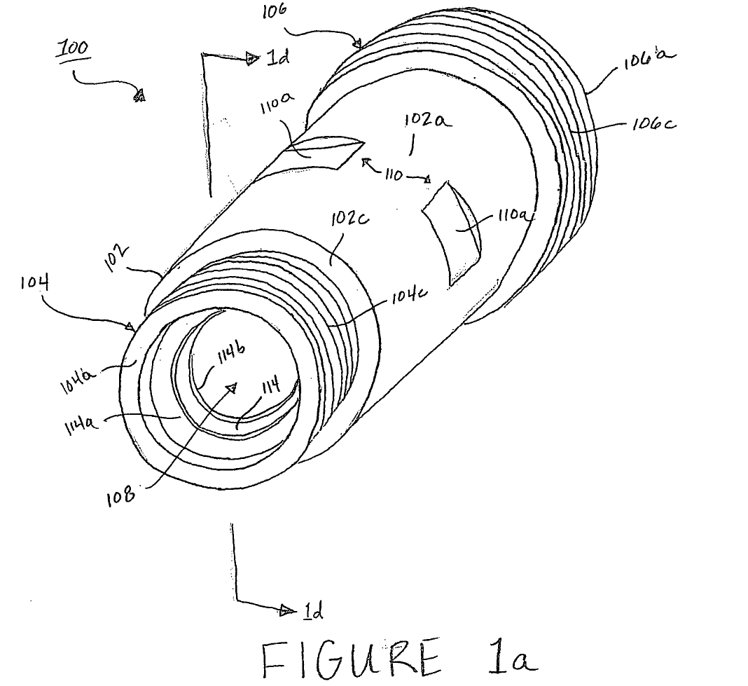

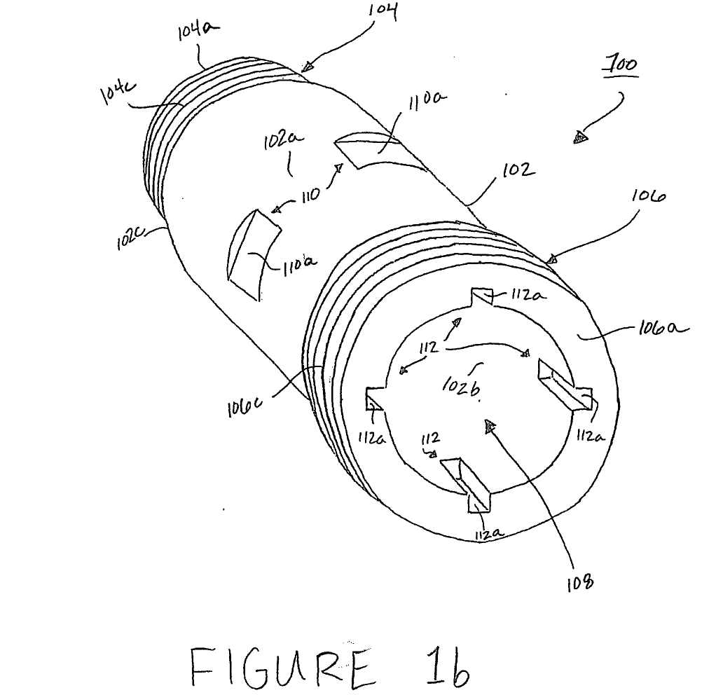

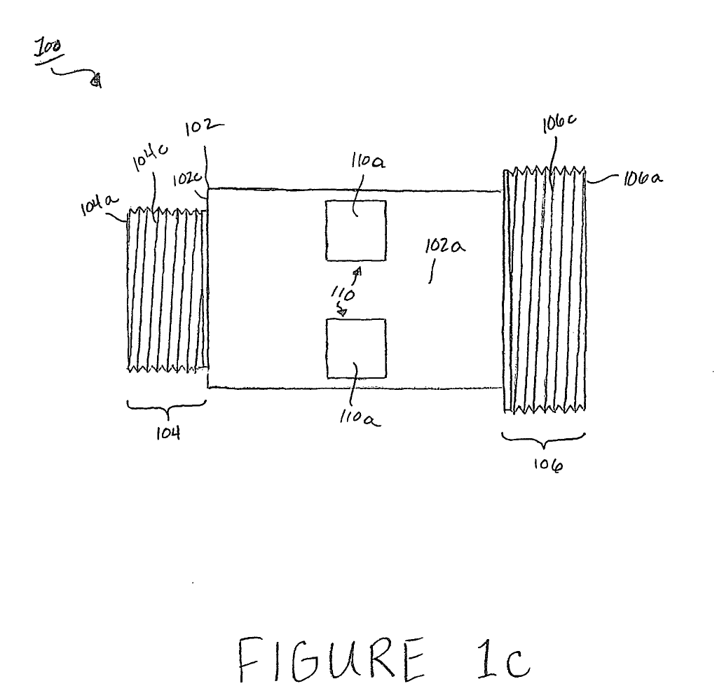

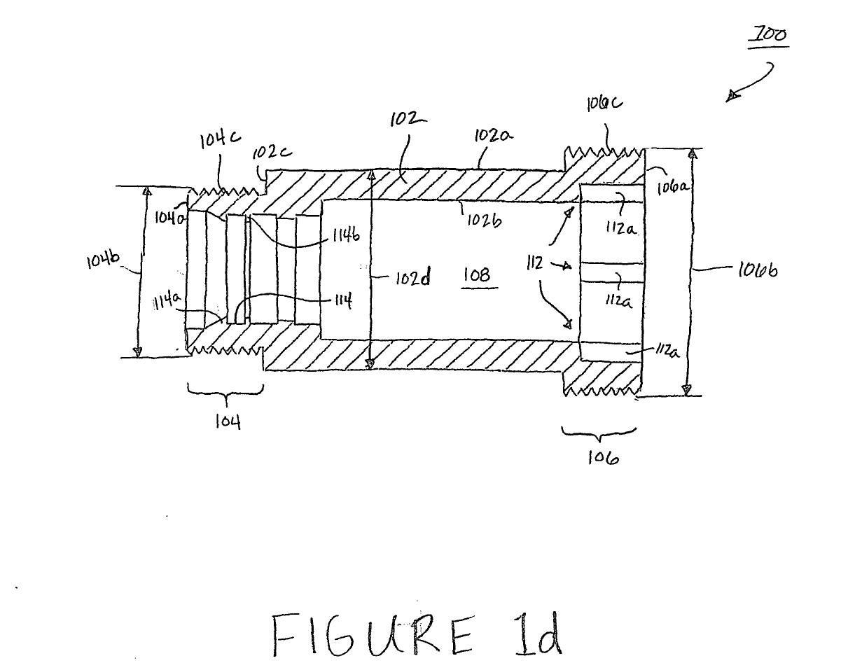

Referring now to FIGS. 1a, 1b, 1c, and 1d, an explosion proof enclosure passageway apparatus 100 is illustrated. The explosion proof enclosure passageway apparatus 100 includes a single-piece tubular member 102 having an outer surface 102a, an inner surface 102b located opposite the outer surface 102a, a stop surface 102c oriented substantially perpendicularly to the outer surface 102a and the inner surface 102b, and a tubular member outer diameter 102d. A first connecting end 104 extends from the tubular member 102 adjacent the stop surface 102c and includes a distal end 104a and a first outer diameter 104b that is less than the tubular member outer diameter 102d. The first connecting end 104 also includes a first enclosure coupling member 104c located along the length of the first connecting end 104 from the distal end 104a to the stop surface 102c that, in an exemplary embodiment, includes a plurality of first threads oriented in a first direction and having a first thread pitch, as illustrated in FIG. 1c. A second connecting end 106 extends from the tubular member 102 opposite the first connecting end 104 and includes and a distal end 106a and a second outer diameter 106b that is greater than the first outer diameter 104a and the tubular member outer diameter 102c. The second connecting end 106 also includes a second enclosure coupling member 106c that, in an exemplary embodiment, includes a plurality of second threads oriented in a second direction which is substantially the same direction as the first direction of the first threads on first enclosure coupling member 104c, and having a second thread pitch that is approximately equal to the first thread pitch on the first threads of first enclosure coupling member 104c, as illustrated in FIG. 1c. In an exemplary embodiment, the first connecting end 104 includes a 3½ inch diameter, the second connecting end 106 includes a 4 inch diameter, and the first thread pitch and the second thread pitch include a thread pitch of 12 threads per inch.

A passageway 108 is defined by the tubular member 102 and extends through the tubular member 102 from the distal end 104a of the first connecting end 104 to the distal end 106a of the second connecting end 106. An apparatus rotating feature 110 is defined by the tubular member 102 and, in an exemplary embodiment, includes a plurality of rotating channels 110a which are located in a substantially equally spaced-apart orientation at 90 degree intervals about the outer surface 102a of the tubular member 102. An apparatus rotating feature 112 is defined by the tubular member 102 and, in an exemplary embodiment, includes a plurality of rotating channels 112a which are located in a substantially equally spaced-apart orientation at 90 degree intervals about the inner surface 102b of the tubular member 102 and immediately adjacent to the passageway 108 and the second connecting end 106. A wire support member channel 114 is defined by the tubular member 102 between a beveled internal flange 114a and an internal flange 114b that extend into the passageway 108 from the inner surface 102b of the tubular member 102, and the wire support member channel 114 is located adjacent the passageway 108 and the first connecting end 104 of the tubular member 102. In an exemplary embodiment, the tubular member 102 is fabricated from a casting process with threads machined on the first connecting end 104 and the second connecting end 106, which allows the tubular member 102 to be manufactured with all the features described above at a lower cost than conventional machining processes typically used to provide similar features on conventional explosion proof enclosure passageway apparatus. In an exemplary embodiment, 6062 Aluminum or a similar corrosion resistant metal is used to fabricate the tubular member 202. In an embodiment, the tubular member 102 is fabricated from a metal having the following approximate as-cast composition: 0.10% copper, 0.20% silicon, 0.25% iron, 0.10-0.25% manganese, 6.2-7.5% magnesium, 0.10-0.25% titanium, 0.05% of each other material with a 0.15% total of other materials, and the remainder aluminum. In an exemplary embodiment, the tubular member 102 has a minimum wall thickness between the first connecting end 104 and the second connecting end 106 of ⅜ inches.

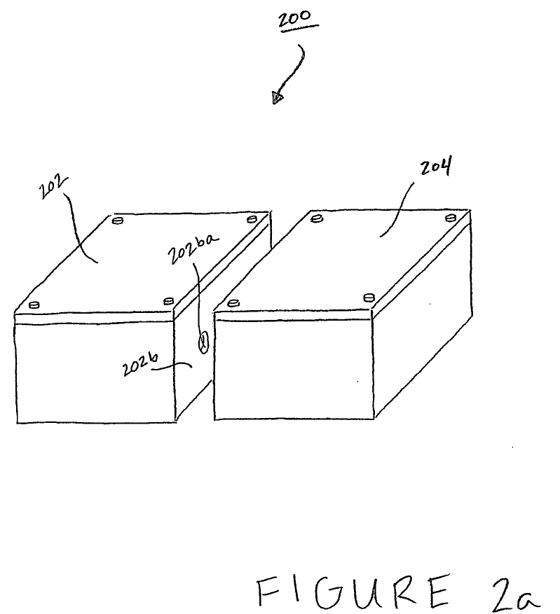

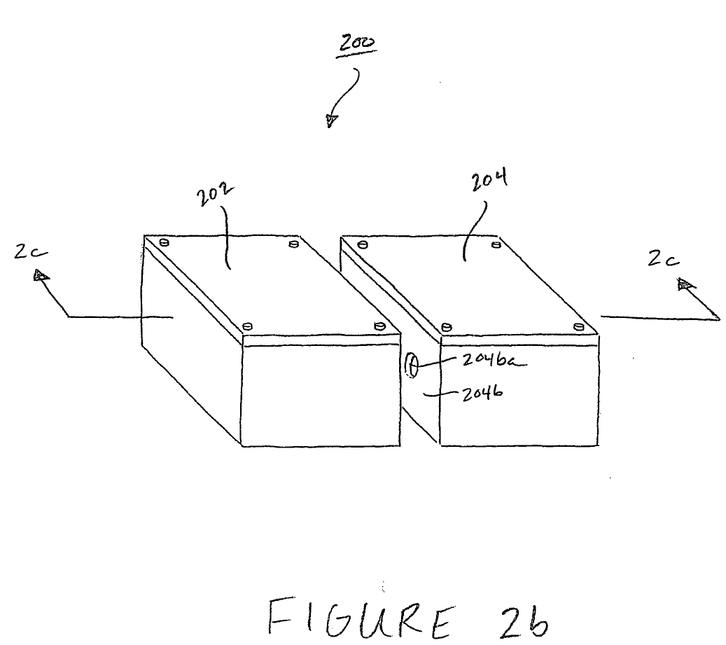

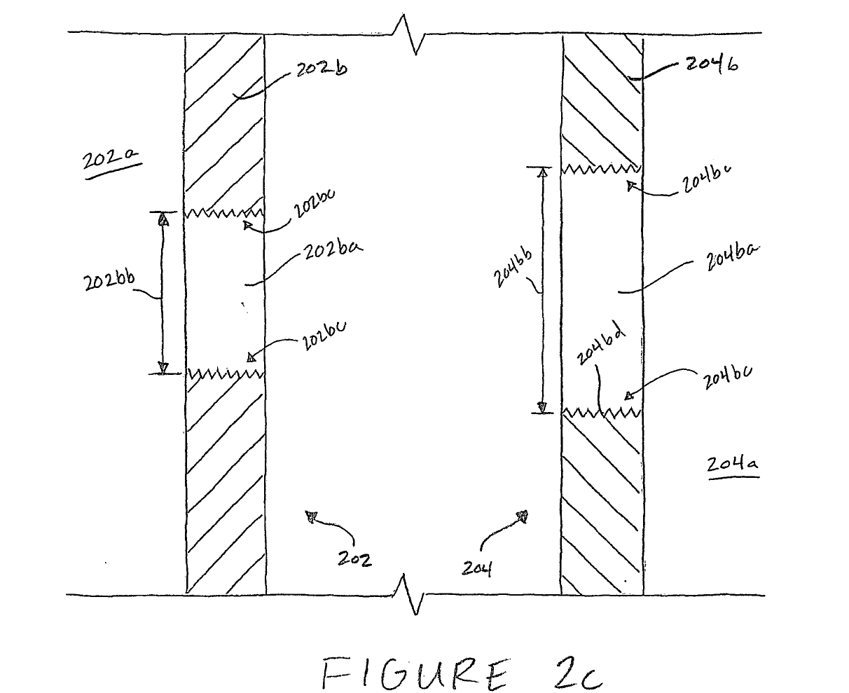

Referring now to FIGS. 2a, 2b, and 2c, an explosion proof enclosure system 200 is illustrated. The explosion proof enclosure system 200 includes a first explosion proof enclosure 202 and a second explosion proof enclosure 204 positioned adjacent the first explosion proof enclosure 202. In an exemplary embodiment, the first explosion proof enclosure 202 and the second explosion proof enclosure 204 may be explosion proof enclosures commercially available from Cooper Crouse-Hinds, P.O. Box 4999, Syracuse, N.Y., 13221, http://www.crouse-hinds.com/, such as, for example D2L enclosures, EPL enclosures, D2D enclosures, and EXD enclosures. The first explosion proof enclosure 202 defines a first housing 202a between a plurality of walls such as, for example, a first wall 202b. The first wall 202b defines a first enclosure entrance 202ba extending through the first wall 202b and providing access to the first housing 202a. The first enclosure entrance 202ba has a first entrance diameter 202bb and includes a first apparatus coupling member 202bc that, in an exemplary embodiment, includes a plurality of first threads oriented in a first direction and having a first thread pitch. The second explosion proof enclosure 204 defines a second housing 204a between a plurality of walls such as, for example, a second wall 204b. The second wall 204b defines a second enclosure entrance 204ba extending through the second wall 204b and providing access to the second housing 204a. The second enclosure entrance 204ba has a second entrance diameter 204bb that is larger than the first entrance diameter 202bb and includes a second apparatus coupling member 204bc that, in an exemplary embodiment, includes a plurality of second threads oriented in a second direction which is substantially the same direction as the first direction of the first threads on first apparatus coupling member 202bc, and having a second thread pitch which is approximately equal to the first thread pitch of first threads on the first apparatus coupling member 202bc. In an exemplary embodiment, the first explosion proof enclosure 202 in the explosion proof enclosure system 200 illustrated above may be replaced with a weather proof enclosure.

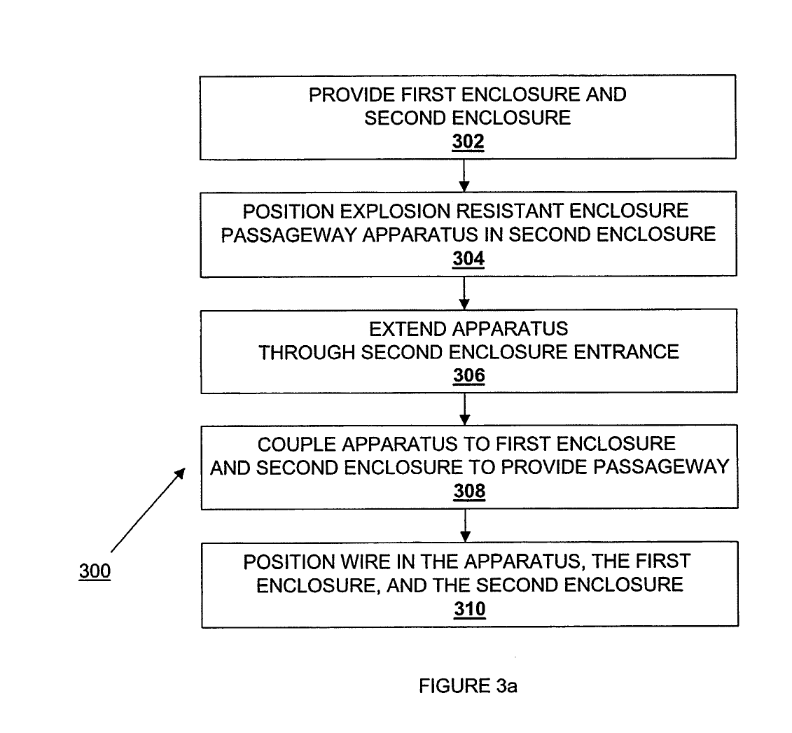

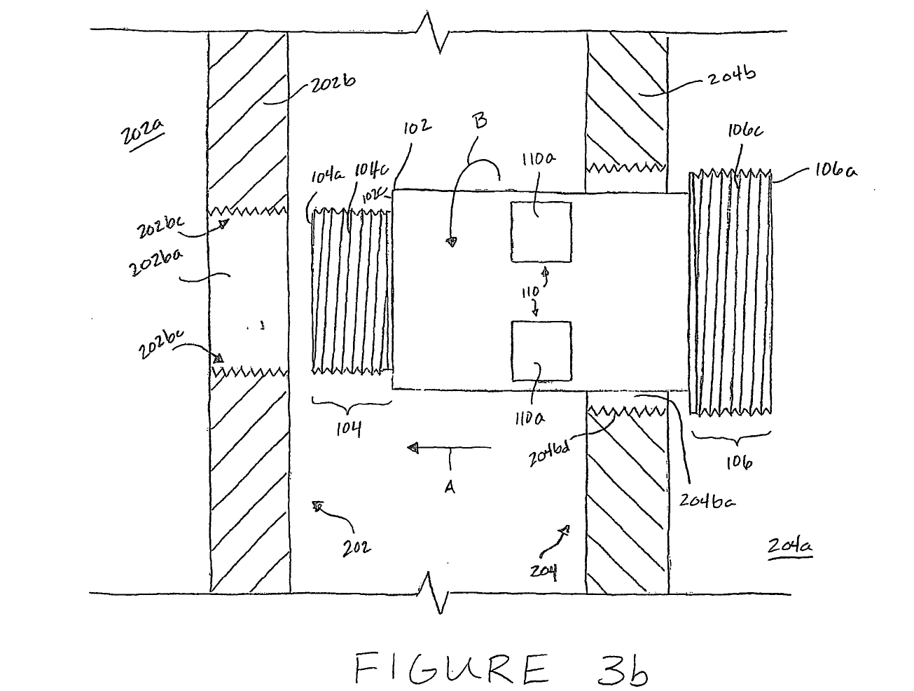

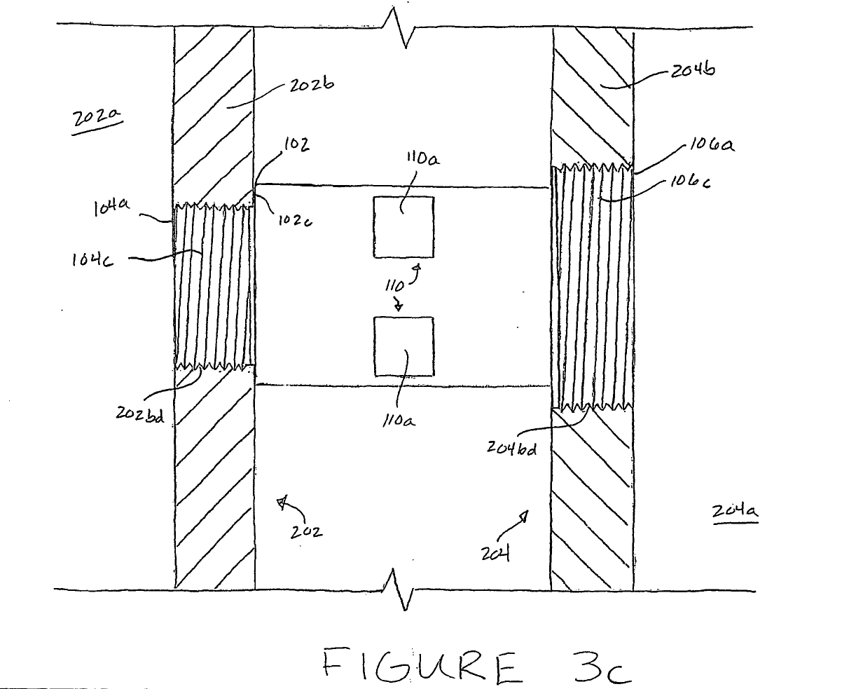

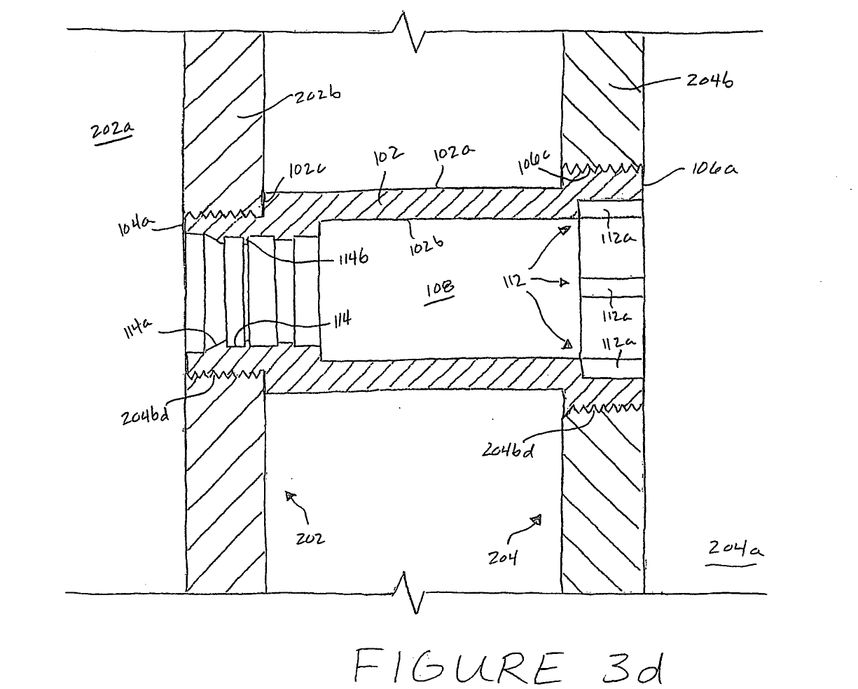

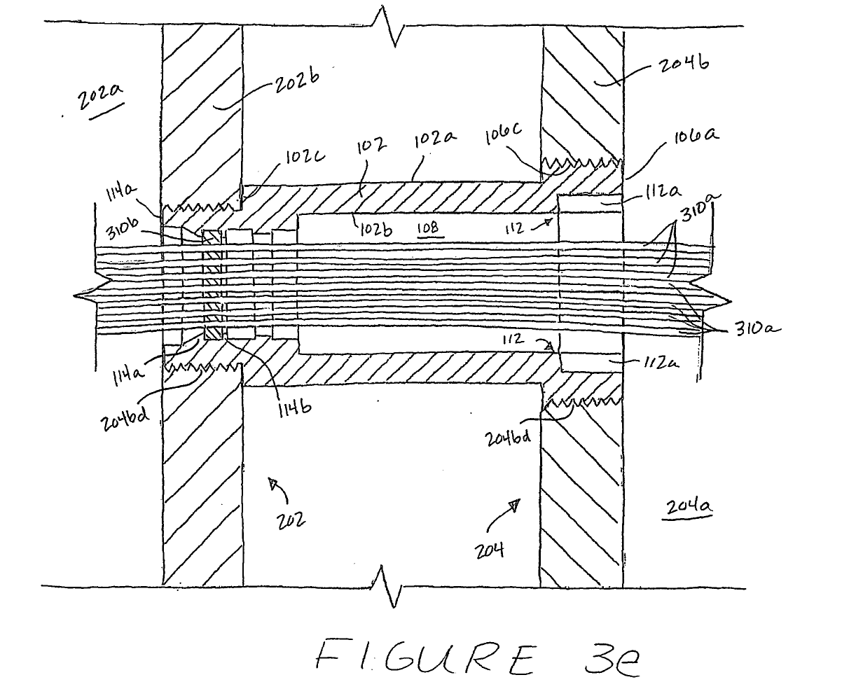

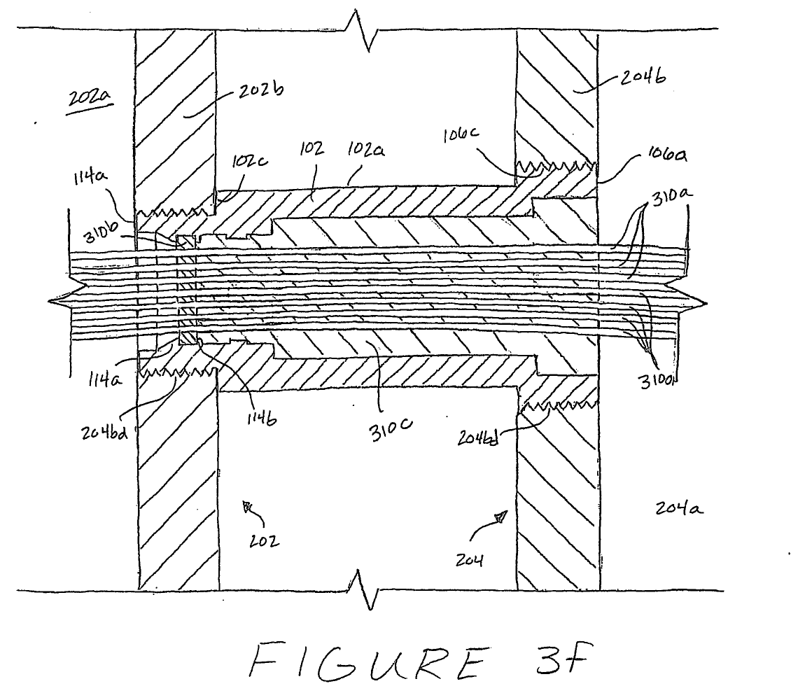

Referring now to FIGS. 1d, 2c, 3a, and 3b, a method 300 for providing a passageway between explosion proof enclosures is illustrated. The method 300 begins at step 302 where the first explosion proof enclosure 202 defining the first enclosure entrance 202ba and the second explosion proof enclosure 204 defining the second enclosure entrance 204ba are provided. The method 300 then proceeds to step 304 where the explosion proof enclosure passageway apparatus 100, described above with reference to FIGS. 1a, 1b, 1c, and 1d, is positioned in the second housing 204a defined by the second explosion proof enclosure 204. The method 300 then proceeds to step 306 where the explosion proof enclosure passageway apparatus 100 is extended through the second enclosure entrance 204ba. The distal end 104a of the first connecting end 104 on the explosion proof enclosure passageway apparatus 100 is positioned adjacent the second enclosure entrance 204ba defined by the second wall 204b of the second explosion proof enclosure 204. The first outer diameter 104b of the first connecting end 104 and the tubular member outer diameter 102d of the tubular member 102 are both smaller than the second entrance diameter 204bb of the second enclosure entrance 204ba, which allows the explosion proof enclosure passageway apparatus 100 to be partially extended through the second enclosure entrance 204ba, as illustrated in FIG. 3b.

Referring now to FIGS. 1d, 2c, 3a, 3b, 3c, and 3d, the method 300 proceeds to step 308 where the explosion proof enclosure passageway apparatus 100 is coupled to the first explosion proof enclosure 202 and the second explosion proof enclosure 204 to provide a passageway. The first outer diameter 104b and the first enclosure coupling member 104c on first connecting end 104 and the first entrance diameter 202bb and the first apparatus coupling member 202bc on the first enclosure entrance 202ba are designed such that the first enclosure coupling member 104c may couple to the first apparatus coupling member 202bc. The second outer diameter 106b and the second enclosure coupling member 106c on second connecting end 106 and the second entrance diameter 204bb and the second apparatus coupling member 204bc on the second enclosure entrance 204ba are designed such that the second enclosure coupling member 106c may couple to the second apparatus coupling member 204bc. The explosion proof enclosure passageway apparatus 100 is moved in a direction A such that the distal end 104a of the first connecting end 104 enters the first enclosure entrance 202ba on the first explosion proof enclosure 202 and the first enclosure coupling member 104c on the first connecting end 104 engages the first apparatus coupling member 202bc on the first explosion proof enclosure 202. In an exemplary embodiment, the explosion proof enclosure passageway apparatus 100 is then rotated in a direction B, which results in the engagement of the first threads on the first enclosure coupling member 104c and the first threads on the first apparatus coupling member 202bc. The rotation of the explosion proof enclosure passageway apparatus 100 may be accomplished by engaging the apparatus rotating feature 112 with a tool such as, for example, a tool which is designed to engage the rotating channels 112a, and rotating the tool in the direction B.

In an exemplary embodiment, when the first enclosure coupling member 104c on the first connecting end 104 engages the first apparatus coupling member 202bc on the first explosion proof enclosure 202, the second enclosure coupling member 106c on the second connecting end 104 of the explosion proof enclosure passageway apparatus 100 engages the second apparatus coupling member 204bc on the second explosion proof enclosure 204. The explosion proof enclosure passageway apparatus 100 is then rotated in the direction B, resulting in the engagement of the second threads on the second enclosure coupling member 106c and the second threads on the second apparatus coupling member 204bc. As the explosion proof enclosure passageway apparatus 100 continues to be rotated in the direction B, the explosion proof enclosure passageway apparatus 100 moves in the direction A until the stop surface 102c on the explosion proof enclosure passageway apparatus 100 engages the first wall 202b on first explosion proof enclosure 202, which results in the coupling of the first enclosure coupling member 104c to the first explosion proof enclosure 202 at approximately the same time as the coupling of the second enclosure coupling member 106c to the second explosion proof enclosure 204. The explosion proof enclosure passageway apparatus 100 is now coupled to and extends between the first explosion proof enclosure 202 and the second explosion proof enclosure 204, providing the passageway 108 between the first explosion proof enclosure 202 and the second explosion proof enclosure 204, as illustrated in FIGS. 3c and 3d.

In an exemplary embodiment, the first enclosure coupling member 104c on the first connecting end 104 engages the first apparatus coupling member 202bc on the first explosion proof enclosure 202 before the second enclosure coupling member 106c on the second connecting end 104 of the explosion proof enclosure passageway apparatus 100 engages the second apparatus coupling member 204bc on the second explosion proof enclosure 204. The explosion proof enclosure passageway apparatus 100 is then rotated in the direction B approximately 360 degrees before the engagement of the second threads on the second enclosure coupling member 106c and the second threads on the second apparatus coupling member 204bc occurs, which aligns the explosion proof enclosure passageway apparatus 100 with the first explosion proof enclosure 202 and can account for variations in the thread start points on the first connecting end 104 and the second connecting end 106. Then, as the explosion proof enclosure passageway apparatus 100 continues to be rotated in the direction B, the explosion proof enclosure passageway apparatus 100 moves in the direction A until the stop surface 102c on the explosion proof enclosure passageway apparatus 100 engages the first wall 202b on first explosion proof enclosure 202, which results in the coupling of the first enclosure coupling member 104c to the first explosion proof enclosure 202 at approximately the same time as the coupling of the second enclosure coupling member 106c to the second explosion proof enclosure 204. The explosion proof enclosure passageway apparatus 100 is now coupled to and extends between the first explosion proof enclosure 202 and the second explosion proof enclosure 204, providing the passageway 108 between the first explosion proof enclosure 202 and the second explosion proof enclosure 204, as illustrated in FIGS. 3c and 3d. In an exemplary embodiment, the first explosion proof enclosure 202 in the explosion proof enclosure system 200 illustrated above may be replaced with a wall defining an aperture that allows the first connecting end 104 to extend through the wall such that a nut may be threaded on the first connecting end 104 in order to couple the explosion proof enclosure passageway apparatus 100 to the wall.

Referring now to FIGS. 1d, 2a, 3a, 3b, 3d, 3e, and 3f, the method 300 then proceeds to step 310 where a wire is positioned in the first explosion proof enclosure 202, the explosion proof enclosure passageway apparatus 100, and the second explosion proof enclosure 204. A plurality of wires 310a are extended from the second housing 204a on the second explosion proof enclosure 204, through the passageway 108 on the explosion proof enclosure passageway apparatus 100, and into the first housing 202a on the first explosion proof enclosure 202, as illustrated in FIG. 3e. A wire support member 310b may be positioned in the wire support member channel 114 on the explosion proof enclosure passageway apparatus 100 and coupled to the plurality of wires 310a such that the plurality of wires 310a are supported and separated in the passageway 108. A sealant 310c is then positioned in the passageway 108 and adjacent the plurality of wires 310a, as illustrated in FIG. 3f. In an exemplary embodiment, the sealant may be a sealant available from Cooper Crouse-Hinds, P.O. Box 4999, Syracuse, N.Y., 13221, http://www.crouse-hinds.com/, such as, for example Chico A sealant or Chico speed seal described at http://www.crouse-hinds.com/crousehinds/resources/MSDS.cfm. In an exemplary embodiment, the tubular member 102 may include at least one connector extending through the passageway 108 such that a plurality of wires may be removeably coupled to the ends of the connector in order to provide an apparatus for removeably extending the wires through the passageway 108 on the tubular member 102. In order to remove the explosion proof enclosure passageway apparatus 100 from the explosion proof enclosure system 200 a tool may be provided which engages the rotating channels 110a of the apparatus rotating feature 110 on the outer surface 102a of the tubular member 102. The tool may then be rotated in a direction opposite to the direction B, which decouples the first connecting end 104 from the first explosion proof enclosure 202 and decouples the second connecting end 106 from the second explosion proof enclosure 204. Thus, a method 300 and apparatus 100 are provided which provide a passageway between enclosures which is more cost-effective to manufacture and easier to assemble than conventional methods and apparatus.

It is understood that variations may be made in the foregoing without departing from the scope of the disclosure.

Any foregoing spatial references such as, for example, “upper,” “lower,” “above,” “below,” “rear,” “between,” “vertical,” “angular,” etc., are for the purpose of illustration only and do not limit the specific orientation or location of the structure described above.

In several exemplary embodiments, it is understood that one or more of the operational steps in each embodiment may be omitted. Moreover, in some instances, some features of the present disclosure may be employed without a corresponding use of the other features. Moreover, it is understood that one or more of the above-described embodiments and/or variations may be combined in whole or in part with any one or more of the other above-described embodiments and/or variations.

Although exemplary embodiments of this disclosure have been described in detail above, those skilled in the art will readily appreciate that many other modifications, changes and/or substitutions are possible in the exemplary embodiments without materially departing from the novel teachings and advantages of this disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

1. An explosion proof enclosure passageway apparatus, consisting of:
a single-piece tubular member having an inner surface defining a passageway,
the single-piece tubular member having
an apparatus rotating feature located on the inner surface and adjacent the passageway;
a first connecting end having a first outer diameter and a first enclosure coupling member;
a first flange adjacent to the first connecting end; and
a second connecting end located opposite the first connecting end and having a second outer diameter and a second enclosure coupling member, whereby the second outer diameter is greater than the first outer diameter and the first enclosure coupling member is operable to couple to a first explosion proof enclosure at approximately the same time as the second enclosure coupling member couples to a second explosion proof enclosure.

2. The apparatus of claim 1, wherein the single-piece tubular member includes a tubular member outer diameter, whereby the tubular member outer diameter is greater than the first outer diameter and less than the second outer diameter.

3. The apparatus of claim 1, wherein the single-piece tubular member is fabricated using a casting process.

4. The apparatus of claim 1, wherein the first enclosure coupling member includes a plurality of first threads oriented in a first direction and having a first thread pitch and the second enclosure coupling member includes a plurality of second threads oriented in a second direction and having a second thread pitch, whereby the first direction is substantially equal to the second direction and the first thread pitch is approximately equal to the second thread pitch.

5. (canceled)

6. The apparatus of claim 1, wherein the apparatus rotating feature includes a plurality of apparatus rotating channels located in a spaced-apart orientation about the single-piece tubular member immediately adjacent the passageway and the second connector end.

7. The apparatus of claim 1, the single-piece tubular member further having:
an outer surface on the single-piece tubular member extending between the first connecting end and the second connecting end; and
an apparatus rotating feature defined by the single-piece tubular member and located adjacent the outer surface.

8. The apparatus of claim 7, wherein the apparatus rotating feature includes a plurality of apparatus rotating channels located in a spaced-apart orientation about the outer surface of the single-piece tubular member.

9. The apparatus of claim 1, the single-piece tubular member further having:
a wire support member channel defined by the single-piece tubular member and located adjacent the passageway.

10. The apparatus of claim 9, the single-piece tubular member further having a wire support member positioned within the wire support member channel.

11-22. (canceled)

23. A method for providing a passageway between enclosures, consisting of:
providing a first explosion proof enclosure defining a first enclosure entrance;
providing a second explosion proof enclosure located adjacent the first explosion proof enclosure and defining a second enclosure entrance;
positioning an explosion proof enclosure passageway apparatus in the second explosion proof enclosure, the explosion proof enclosure passageway apparatus, consisting of:
a single-piece tubular member defining a passageway, wherein the single-piece tubular member includes a first connecting end, a first flange located adjacent to the first connecting end, and a second connecting end located opposite the first connecting end;
extending the explosion proof enclosure passageway apparatus through the second enclosure entrance;
providing the passageway between the first explosion proof enclosure and the second explosion proof enclosure by coupling the explosion proof enclosure passageway apparatus to the first explosion proof enclosure and the second explosion proof enclosure by engaging the first connecting end with the first enclosure entrance and the second connecting end with the second enclosure entrance at approximately the same time;
positioning at least one wire in the first explosion proof enclosure, the explosion proof enclosure passageway apparatus, and the second explosion proof enclosure.

24. (canceled)

25. The method of claim 23, wherein the positioning includes coupling a wire support member to the explosion proof enclosure passageway apparatus and coupling the at least one wire to the wire support member.

26. The method of claim 23, wherein the positioning includes providing a sealant in the explosion proof enclosure passageway and adjacent the at least one wire.

27. An explosion proof enclosure passageway apparatus, consisting of:
a single-piece tubular member having an inner surface defining a passageway and having an outer surface having a tubular member outer diameter;
wherein the single-piece tubular member includes:
a first connector end located on the single-piece tubular member adjacent the outer surface and having a first outer diameter and a plurality of first threads oriented in a first direction and having a first thread pitch;
a first flange located on the single-piece tubular member adjacent to the first connector end and having the tubular member outer diameter;
a second connector end located on the single-piece tubular member adjacent the outer surface opposite the first connecting end and having a second outer diameter and a plurality of second threads oriented in a second direction that is substantially equal to the first direction and having a second thread pitch that is approximately equal to the first thread pitch;
a second flange located on the second connector end and having the second outer diameter, whereby the tubular member outer diameter is greater than the first outer diameter and less than the second outer diameter and the first enclosure coupling member is operable to couple to a first explosion proof enclosure at approximately the same time as the second enclosure coupling member couples to a second explosion proof enclosure;
a plurality of first apparatus rotating channels defined by the single-piece tubular member on the inner surface and located in a spaced-apart orientation about the single-piece tubular member immediately adjacent the passageway and the second connector end;
a plurality of second apparatus rotating channels defined by the single-piece tubular member on the outer surface and located in a spaced-apart orientation about the outer surface of the single-piece tubular member; and
a plurality of channels defined by the single-piece tubular member, wherein one of the channels is a wire support member channel that is located adjacent the passageway and the first connector end.

28. (canceled)

29. (canceled)

30. The apparatus of claim 1, the single-piece tubular member further having:
a second flange located on the second connecting end, wherein an outer diameter of the second flange is greater than an outer diameter of the first flange.

31. The apparatus of claim 1, wherein at least one of the first and second enclosures is selected from the group consisting of explosion-proof enclosures, weather-proof enclosures, and walls.

32. The apparatus of claim 9, the single-piece tubular member further having:
a first internal flange and a second internal flange, wherein the wire support member channel is positioned between the first and second internal flanges.

33. The apparatus of claim 32, wherein at least one of the first and second internal flanges is beveled.

34. (canceled)

35. The apparatus of claim 27, the single-piece tubular member further having:
a first internal flange and a second internal flange, wherein the wire support member channel is positioned between the first and second internal flanges.

36. The apparatus of claim 27, wherein at least one of the first and second internal flanges is beveled.

37. The apparatus of claim 27, wherein the single-piece tubular member further includes at least one connector extending through the passageway, and wherein the at least one wire is removably coupled to the at least one connector.

38. An explosion proof enclosure passageway apparatus system, consisting of:
a first explosion proof enclosure defining a first enclosure entrance and configured to house first equipment;
a second explosion proof enclosure defining a second enclosure entrance and configured to house second equipment;
a single-piece tubular member defining a passageway;
at least one wire located in the first explosion proof enclosure, the passageway, and the second explosion proof enclosure; and
a wire support member located in the passageway and adjacent the at least one wire;
wherein the single-piece tubular member includes a first connecting end having a first outer diameter and a first enclosure coupling member, and a second connecting end located opposite the first connecting end and having a second outer diameter and a second enclosure coupling member, whereby the second outer diameter is greater than the first outer diameter and the first enclosure coupling member is operable to couple to the first explosion proof enclosure at approximately the same time as the second enclosure coupling member couples to the second explosion proof enclosure.

39. An explosion proof enclosure passageway apparatus, consisting of:
a single-piece tubular member defining a passageway,
the single-piece tubular member having
a first connecting end having a first outer diameter and a first enclosure coupling member;
a first flange adjacent to the first connecting end;
a second connecting end located opposite the first connecting end and having a second outer diameter and a second enclosure coupling member;
an outer surface on the single-piece tubular member extending between the first connecting end and the second connecting end; and
an apparatus rotating feature defined by the single-piece tubular member on the outer surface,
whereby the second outer diameter is greater than the first outer diameter and the first enclosure coupling member is operable to couple to a first explosion proof enclosure at approximately the same time as the second enclosure coupling member couples to a second explosion proof enclosure.

40. The apparatus of claim 39, wherein the single-piece tubular member includes a tubular member outer diameter, whereby the tubular member outer diameter is greater than the first outer diameter and less than the second outer diameter.

41. The apparatus of claim 39, wherein the first enclosure coupling member includes a plurality of first threads oriented in a first direction and having a first thread pitch and the second enclosure coupling member includes a plurality of second threads oriented in a second direction and having a second thread pitch, whereby the first direction is substantially equal to the second direction and the first thread pitch is approximately equal to the second thread pitch.

42. The apparatus of claim 39, wherein the apparatus rotating feature includes a plurality of apparatus rotating channels located in a spaced-apart orientation about the outer surface of the single-piece tubular member.

43. The apparatus of claim 39, the single-piece tubular member further having:
a wire support member channel defined by the single-piece tubular member and located adjacent the passageway.

44. The apparatus of claim 43, the single-piece tubular member further having a wire support member positioned within the wire support member channel.
